(19) United States
(12) Patent Application Publication
(10) Pub. No.: US 2026/0023978 A1
(43) Pub. Date: Jan. 22, 2026

(54) DEVICE AND METHOD FOR DETECTING ANOMALIES IN DOUBLE-PARTY INTERACTION DATA

(71) Applicant: Grabtaxi Holdings Pte. Ltd, Singapore (SG)

(72) Inventors: Rizal Zaini Ahmad FATHONY, Jakarta Selatan, Cilandak (ID); Xue Fang NG, Singapore (SG); Jia CHEN, Singapore (SG)

(21) Appl. No.: 18/998,527

(22) PCT Filed: Aug. 15, 2023
(86) PCT No.: PCT/SG2023/050561

§ 371 Date: Jan. 27, 2025

(30) Foreign Application Priority Data
Aug. 15, 2022 (SG) 10202250738J

(51) Int. Cl. G06N 3/091; G06N 3/042; G06N 3/0455; G06N 3/0464

(52) U.S. Cl. CPC G06N 3/091; G06N 3/042; G06N 3/0455; G06N 3/0464

(57) ABSTRACT

Aspects concern a method for detecting anomalies in double-party interaction data, comprising representing interactions between parties of a first group and parties of a second group as a graph, wherein each interaction between a first party of the first group and a second party of the second group is represented by an edge between a respective first node representing the first party and a respective second node representing the second party and wherein information about the first party is assigned to the first node as node attribute information, information about the second party is assigned to the second node as node attribute information and information about the interaction is assigned to the edge as edge attribute information, processing the graph by a graph convolutional neural network having an autoencoder structure, deriving anomaly scores for interactions, parties of the first group and parties of the second group from a reconstruction loss between the graph and an output of the graph convolutional neural network in response to the graph including at least a loss between the edge attribute information and edge attribute information reconstructed by a decoder of the graph convolutional neural network and detecting anomalies based on the anomaly scores.

### TECHNICAL FIELD

Various aspects of this disclosure relate to devices and methods for detecting anomalies in double-party interaction data.

### BACKGROUND

Identifying behaviours that differ singularly from the majority has become an important area in various applications across many industries. The occurrence of these (usually rare) anomaly behaviours may have serious implications in many domains. In a manufacturing environment, for example, the occurrence of anomaly events may indicate errors in a workflow (e.g. in the interaction of robot devices). In a network security system, anomalous events could mean security breaches or network intrusions and in the e-commerce business, their occurrence could suggest e-commerce frauds such as price/promotion abuse, review/rating gaming, or fraud collusion.

For this reason, effective approaches for anomaly detection for many domains as mentioned above as well as other domains such as manufacturing, healthcare, insurance, medicine, and many others are desirable.

### SUMMARY

Various embodiments concern a method for detecting anomalies in double-party interaction data, comprising representing interactions between parties of a first group and parties of a second group as a graph, wherein each interaction between a first party of the first group and a second party of the second group is represented by an edge between a respective first node representing the first party and a respective second node representing the second party and wherein information about the first party is assigned to the first node as node attribute information, information about the second party is assigned to the second node as node attribute information and information about the interaction is assigned to the edge as edge attribute information. The method further comprises processing the graph by a graph convolutional neural network having an autoencoder structure, deriving anomaly scores for interactions, parties of the first group and parties of the second group from a reconstruction loss between the graph and an output of the graph convolutional neural network in response to the graph including at least a loss between the edge attribute information and edge attribute information reconstructed by a decoder of the graph convolutional neural network. Anomalies are detected based on the anomaly scores.

According to one embodiment, the reconstruction loss includes a loss between node attribute information and node attribute information reconstructed by the decoder.

According to one embodiment, the reconstruction loss includes a loss between node adjacency information of the graph and node adjacency information reconstructed by the decoder.

According to one embodiment, the method comprises comparing the anomaly scores with one or more threshold values and detecting an anomaly of an interaction, party of the first group or party of the second group if its anomaly score is above a respective threshold value.

According to one embodiment, the method comprises training the graph convolutional neural network by, determining, for each training data element of a plurality of training data elements, wherein each training data element comprises a training graph, a reconstruction loss between the training graph and an output of the graph convolutional neural network in response of the training graph and an output of the graph convolutional neural network in response to the graph including at least a loss between the edge attribute information and edge attribute information reconstructed by a decoder of the graph convolutional neural network, and adapting the neural network to reduce an overall loss including the reconstruction losses determined for the training data elements.

According to one embodiment, the method comprises, for each training data element, sampling sub-graphs of the training graph, for each sampled sub-graph setting a reconstruction target to the sampled sub-graph and expanding the sub-graph by including nodes and edges connected to the sampled sub-graph and computing a reconstruction between the reconstruction target and an output of the graph convolutional neural network in response to the expanded sub-graph, wherein the overall loss includes the reconstruction losses determined for the sub-graphs.

According to one embodiment, the first group of parties are customers and the second group of parties are service providers.

According to one embodiment, the interactions are transactions between the first group of parties and the second group of parties.

According to one embodiment, the method comprises detecting fraud based on the detected anomalies.

According to one embodiment, the method comprises checking, for each detected anomaly, whether there has been fraud.

According to one embodiment, the method further comprises utilizing the anomaly score as the input to a human-in-the-loop actioning system and/or an automatic actioning system. These may take corresponding actions if there is an anomaly, such as blocking a customer involved in an anomaly (i.e. an interaction whose anomaly score indicates an anomaly) from certain features.

According to one embodiment, a server computer is provided including a radio interface, a memory interface and a processing unit configured to perform the method for detecting anomalies in double-party interaction data described above.

According to one embodiment, a computer program element is provided including program instructions, which, when executed by one or more processors, cause the one or more processors to perform the method for detecting anomalies in double-party interaction data described above.

According to one embodiment, a computer-readable medium is provided including program instructions, which, when executed by one or more processors, cause the one or more processors to perform the method for detecting anomalies in double-party interaction data described above.

### BRIEF DESCRIPTION OF THE DRAWINGS

The invention will be better understood with reference to the detailed description when considered in conjunction with the non-limiting examples and the accompanying drawings, in which:

FIG. 1 shows a communication arrangement including a smartphone and a server.

FIG. 2 illustrates a data processing pipeline according to an embodiment, i.e. implemented by the server.

FIG. 3 shows a graph anomaly detection neural network according to an embodiment.

FIG. 4A illustrates the message passing flow for a customer node.

FIG. 4B illustrates the message passing flow for a service provider node.

FIG. 4C illustrates the message passing flow for an edge.

FIG. 5 shows a flow diagram illustrating a method for detecting anomalies in double-party interaction data.

FIG. 6 shows a server computer according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

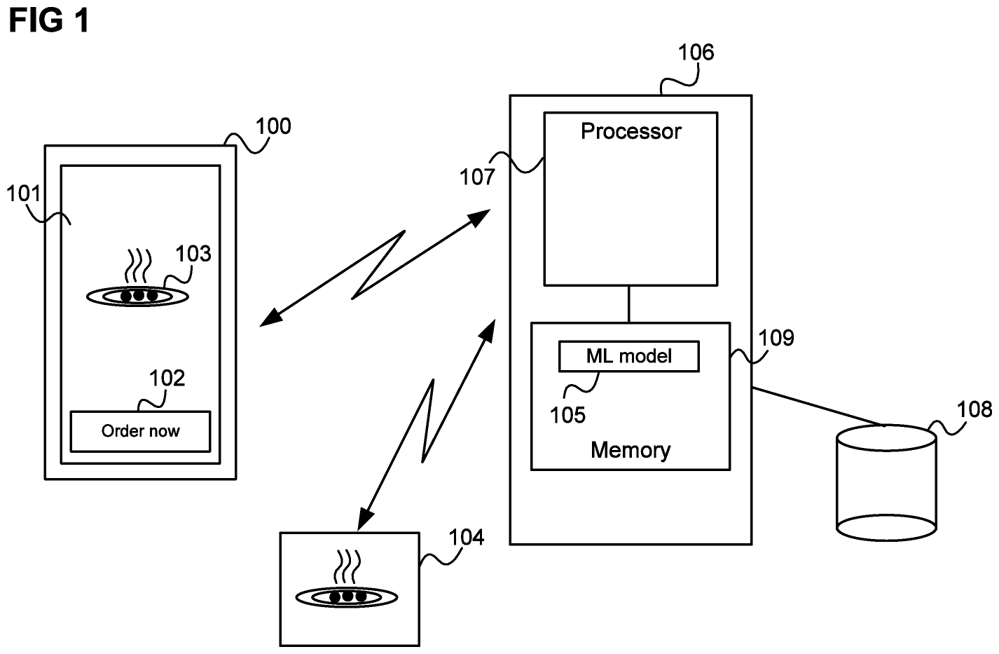

FIG. 1 shows a communication arrangement including a smartphone 100 and a server (computer) 106.

The smartphone 100 has a screen showing the graphical user interface (GUI) of an app for using one or more of various services, such as ordering food or e-hailing, which the smartphone's user has previously installed on his smartphone and has opened (i.e. started) to use the service, e.g. to order food.

The GUI 101 includes graphical user interface elements 102, 103 helping the user to use the service, e.g. a map of a vicinity of the user's position, food available in the user's vicinity (which the app may determine based on a location service, e.g. a GPS-based location service), a button for placing an order, etc.

When the user has made a selection for a service, e.g. a selection of a restaurant or an online supermarket and/or a selection of food or groceries to order, the app communicates with a server 106 of the respective service via a radio connection. The server 106 (carrying out a corresponding server program by means of a processor 107) may consult a memory 109 or a data storage 108 having information regarding the service (e.g. prices, availability, estimated time for delivery etc.) The server communicates any data relevant or requested by the user (such as estimated time for delivery) back to the smartphone 100 and the smartphone 100 displays this information on the GUI 101. The user may finally accept a service, e.g. order food. In that case, the server 106 informs the service provider 104, e.g. a restaurant or online supermarket accordingly. The server 106 may also communicate earlier with the service provider 104, e.g. for determining the estimated time for delivery.

It should be noted while the server 106 is described as a single server, its functionality, e.g. for providing a certain service and advertisement data will in practical application typically be provided by an arrangement of multiple server computers (e.g. implementing a cloud service). Accordingly, the functionality described in the following provided by a server (e.g. server 106) may be understood to be provided by an arrangement of servers or server computers.

The server 106 may store information about interactions between parties, in this example transactions between users like the user of the smartphone 100 and service providers like the service provider 104 in the data storage 108 for analysis.

These data can thus be modelled as data about double-party interactions. For example, both food order and grocery transactions as well as e-hailing trips (which also can be seen to correspond to a transaction since the passenger pays for the trip) form interactions between customers and merchants (in general service providers including for example also drivers). These interactions are rich with information, for example, information about the orders, food category purchased, prices, drop-off locations, etc. Using these data, it may be desirable to detect anomalies in these double-party interactions since anomalies in the transactions often indicate the occurrence of fraudulent activities committed by the parties involved. For example, promotion gaming of a customer for a certain merchant where very frequent orders or made, and customer-merchant collusions where the transactions to the merchant are mostly from the colluding customer. Fraudsters tend to repeat the fraudulent behaviours to maximize the gain, thus making the behaviours stand out from others.

It is desirable that anomaly detection models do not need labelled data such that they can be directly applied to the gathered data without the need to collect labels, which oftentimes are limited and time-consuming to collect. Moreover, fraudsters keep innovating on their fraud modus operandi (MOs), making any model that relies on historical labelled data unable to effectively detect new MOs. However, many classical machine learning algorithms for anomaly detection are unable to model the rich information in the double-party interactions.

In particular, anomaly models that work on tabular data cannot effectively model the interactions since they force the data to be put in tabular format, which destroys the relational property between two different parties.

Further, conventional anomaly models that model relational data and work on interaction data are not capable of modelling the rich information attached to the customer-service provider interactions. Typically they focus on the individual property of each entity (e.g., either customer's properties or service provider's properties).

In view of the above, according to various embodiments, an approach for anomaly detection in double-party interactions is provided which allows the modelling the rich information attached to the interactions.

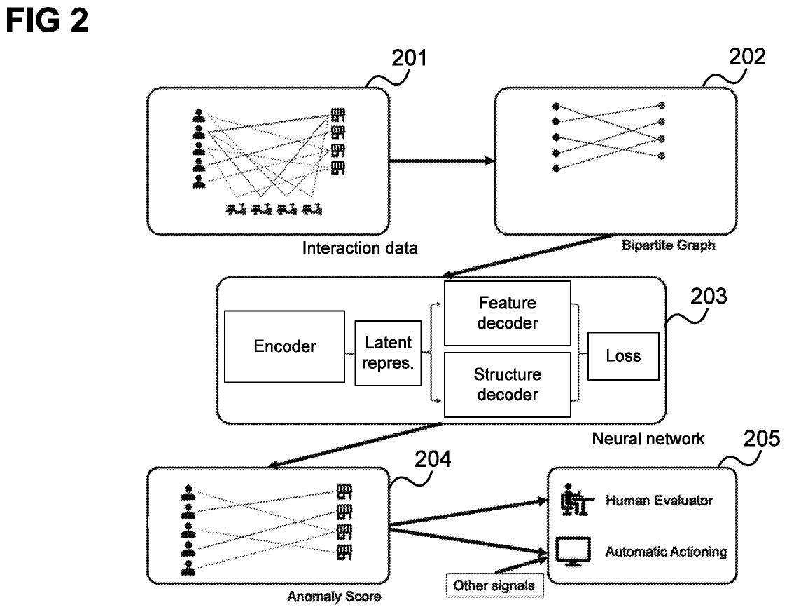

FIG. 2 illustrates a data processing pipeline according to an embodiment, i.e. implemented by the server 106.

First, a data ingestion system 201 gathers raw interaction data between customers (PAX) and service providers (MEX), e.g. in the data storage 108 as described above for food transactions, grocery transactions, e-hailing trips etc.

The gathered data is then formulated (i.e. represented as an attributed bipartite graph 202, i.e. as a mathematical formulation for representing double-party interactions.

Specifically, the bipartite graph is a node-and-edge-attributed graph G=( [symbol] , [symbol] , ε, X^{u},X^{v},X^{e}). It consists of:
the first set of nodes [symbol] ={u₁,u₂, . . . ,uₙ_{ᵤ}}, representing the customer nodes;
the second set of nodes [symbol] ={v₁,v₂, . . . ,Vₙ_{ᵥ}}, representing the service provider nodes;
the set of edges E, indexed using e_{i,j} where i∈{1, . . . ,nᵤ} and j∈{1, . . . , nᵥ}, with nₑ represents its cardinality, representing the customer-service provider interactions;
X^{u}∈Rⁿ^{ᵤ}^{×m}^{ᵤ}, the attributes/features for every node in [symbol] ;
X^{v}∈Rⁿ^{ᵥ}^{×m}^{ᵥ}, the attributes/features for every node in [symbol] ;
X^{e}∈Rⁿ^{ₑ}^{×m}^{ₑ}, the attributes/features for every edge in ε.

Here, n represents the number of nodes/edges in the graph, and m represents the number of node/edge features. The subscripts in n and m indicate which set the numbers represent (e.g., nᵤ for the set [symbol] and nₑ for the set of edges ε).

For example, the data ingestion system 201 gathers data about transactions between customers and service providers (e.g. restaurants and online supermarkets) for the past 7 days. The data may comprise many (e.g. around 30-50) features per transaction and/or party (i.e. customer or service provider) for example information about orders, food category purchased, prices, drop-off locations, number of orders, prices, promotions, drop-off location statistics, etc. From these transactions, the bipartite graph is constructed wherein each node in the bipartite graph represents a customer or a service provider (i.e. e.g. merchant or driver), i.e. each node is either a customer node or a service provider node. An edge between a customer and a service provider exists in the bipartite graph if the customer made at least one transaction with the service provider.

Each edge is supplied with rich information (i.e. attributes also referred to as features) regarding the transactions between the corresponding customer and service provider (which correspond to the nodes the edge connects). Similarly, each node is also supplied with information about the customer's or service provider's profile, respectively.

So, for example, the transactions between customers and service providers over multiple services are monitored, e.g. for both food and online supermarket orders and, for example, every day, the data ingestion system 201 extracts the food and online supermarket transactions in the past seven days in the dataset, as well as additional information, including number of orders, prices, promotions, order information, drop-off location statistics, etc. From these transactions, the server 106 constructs a bipartite graph representation of the dataset.

The bipartite graph 202 constructed by the data ingestion system 201 is then passed to a graph anomaly detection machine learning (ML) model 203, e.g. neural network (e.g. implemented by the server 106). The anomaly ML model 203 is a graph neural network model designed specifically for anomaly detection in bipartite graphs. The input to the ML model 203 is an attributed bipartite graph 202 which comprises features (or attributes) to encode the gathered data as described above. From the output of the graph anomaly detection neural network 203 in response to the bipartite graph 202, an anomaly scoring system 204 determines anomaly scores 204 for each customer-service provider pair, as well as an anomaly score for every customer and every provider pair.

The anomaly scores may then be evaluated by an actioning system 205 (e.g. by comparing them with one or more thresholds) which may take actions in response to the detection of anomalies. For example, the anomaly score for customer-service provider pairs is used for determining whether the pair is anomalous, such a customer colluding with service provider for abusing promotions.

The graph anomaly detection neural network 203 is first trained before it is used for anomaly detection. After the graph anomaly detection neural network 203 as been trained, it may be used to generate the anomaly scores. The anomaly score is based on each individual node/edge's reconstruction error from the graph anomaly detection neural network 203 output. This can be seen to be based on the assumption that normal behaviours are common and hence can be easily reconstructed, whereas anomalous behaviours are rare and the model will have problems in reconstructing them. Consequently, the anomalous edges/nodes will have higher reconstruction error, and thus higher anomaly score. The anomaly scores may be in an arbitrary range of non-negative numbers. In practical application, most of the anomaly scores are typically close to 0, but some can be in the tens, or hundreds.

The anomaly scoring system 204 first calculates the anomaly score for each edge (i.e. each customer-service provider relation) using the respective edge reconstruction error. Then it calculates the anomaly score for the nodes (i.e. customers and service providers). The anomaly score for a node does not only depend on the customer's or service provider's reconstruction error, but also considers all edges that are connected to the node. The anomaly scores for each customer, each service provider, and each customer-service provider interactions for every run day may be stored in the database 108.

The anomaly scores produced by the anomaly scoring system 204 are then passed to the actioning system 205. The actioning system 205 may for example comprise a human-in-the-loop system, and an automatic actioning system. For the human-in-the-loop system, a set of human expert is provided with sets of most anomalous customers, merchants, and customer-merchant interactions. The human evaluator then manually investigates anomalies, evaluating if a particular modus operandi (old or new) occurred, and decides on what action to perform with regard to the suspected customer or service provider. For the automatic actioning system, the anomaly score is combined with other signals or data to create an automatic actioning task like for example, automatically banning certain promos for users with high anomaly score in the past few days.

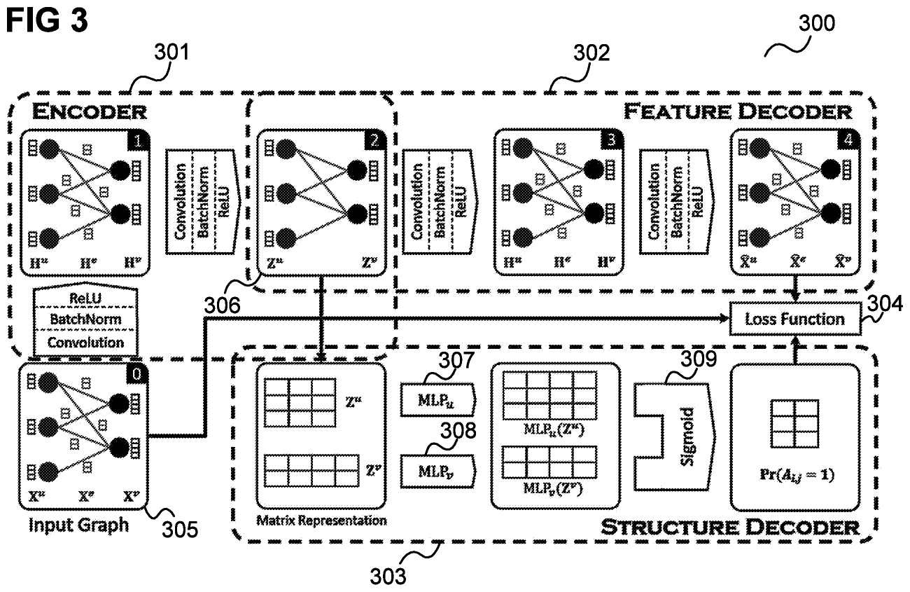

The graph anomaly detection neural network 203 is now described in more detail with reference to FIG. 3.

FIG. 3 shows a graph anomaly detection neural network 300 according to an embodiment.

The graph anomaly detection neural network 300 includes an encoder 301 and a decoder which includes a feature decoder 302 and a structure decoder 303. The graph anomaly detection neural network 300 is trained in accordance with a loss function 304 (i.e. in training it is adapted to reduce the value of the loss function for training data).

The encoder 301 takes the input graph 305 (including the feature/attribute information), and processes it in a series of graph convolution layers. According to various embodiments, a customized convolution operation is used that works on a bipartite graph with both node and edge features. Each convolution layer is followed by a batch normalization and a ReLU Rectified Linear Unit activation function, to produce the layer's representation of node and edge, denoted as H^{u}, H^{v}, and H^{e}. The last layer of the encoder 301 produces a latent representation 306 for each node denoted as Z^{u} and Z^{v}, respectively.

The feature decoder 302 is trained to aim to reconstruct the original input features from the latent representation 306 by passing Z^{u} and Z^{v} to a series of graph convolution layers. The final output is the reconstructed node and edge features, denoted as X^{u}, \hat{X}ᵥ, and X^{e}, respectively.

The structure decoder 303 is trained to aim to reconstruct the original graph structure from the latent representation 306. It works by forming a matrix representation of Z^{u} and Z^{v}, applying multi-layer perceptron (MLPs) on both Z^{u} and Z^{v}, and then using the sigmoid function to produce the probability that node u is connected to node v via an edge.

For training the graph anomaly detection neural network 300, the loss function 304 includes (for each training data element (i.e. training input graph) of the training data) a reconstruction error which is a combination of the mean squared error of the feature reconstruction (feature decoder output) and the binary cross-entropy of the edge prediction (structure decoder output).

In the following, the operation of the graph anomaly detection neural network 300 is described in further detail, starting with some notations used in the following.

The structure of the attributed graph G is represented in by adjacency-like matrix A∈ [symbol] ⁿ^{ᵤ}^{×n}^{_{ν}}, where its (i,j)-th item A_{i,j}=1 if there is an edge between uᵢ and vⱼ and A_{i,j}=0 else. It should be noted that unlike the adjacency matrix in a regular (homogeneous) graph, the matrix A does not need not be a square matrix as the number of nodes in [symbol] and [symbol] can be different. Further, [symbol] is defined as the neighbouring operator that returns the list of all of neighbouring nodes. Specifically, for a node u in the first node set (customer nodes),

$$𝒩 ( {u}_{i} ) = \{ {υ}_{j} ∈ 𝒱 \vert {A}_{i , j} = 1 ; j ∈ \{ 1 , … , {n}_{υ} \} \}$$

Similarly, for a node v in the second node set (service provider nodes),

$$𝒩 ( {υ}_{j} ) = \{ {u}_{i} ∈ 𝒰 \vert {A}_{i , j} = 1 ; i ∈ \{ 1 , … , {n}_{u} \} \}$$

In addition, another function [symbol] is defined which behaves similarly to [symbol] . However, instead of returning neighbouring nodes, it returns the edges connecting the target node to the neighbouring nodes. In particular,

$$ℳ ( {u}_{i} ) = \{ {e}_{i , j} ∈ ℰ \vert {A}_{i , j} = 1 ; j ∈ \{ 1 , … , {n}_{υ} \} \} \\ And \\ ℳ ( {υ}_{j} ) = \{ {e}_{i , j} ∈ ℰ \vert {A}_{i , j} = 1 ; i ∈ \{ 1 , … , {n}_{u} \} \}$$

The anomaly detection task can now be formalized as follows: given a bipartite node-and-edge-attributed graph G, the task is to produce scoring functions applicable to each edge e∈ε, as well as each node u∈ [symbol] and v∈ [symbol] such that the edges/nodes that differ singularly from the majority in terms both the structure and attribute information should be given higher anomaly score.

Specifically, the task includes providing three scoring functions: scoreₑ(.) scoreᵤ(.) and scoreᵥ(.) each for scoring the edges, the nodes in [symbol] and the nodes in [symbol] , respectively.

The key components of the graph anomaly detection neural network 300 as described in the following may be seen in the graph convolution operation and the message passing scheme that compute the next (i.e. next layer's) node and edge representations from the current ones (i.e. current layer's).

In the following, lower case x is used to denote node/edge features, with a sub-script to enumerate the nodes/edges. Let

$${x}_{i}^{u}$$

denote the features for node uᵢ in [symbol] with i∈{1, . . . , nᵤ},

$${x}_{j}^{υ}$$

denote the features for node vⱼ in [symbol] with i∈{1, . . . , n_{ν}}, whereas

$${x}_{i , j}^{e}$$

denotes the features for edge e_{i,j} in ε.

The graph anomaly detection neural network 300 comprises several convolution layers. Let K denote the number of convolution layers (even number), where half of are part of the encoder 301 and the other are part of the feature decoder 302. The lower case k is used to enumerate the convolution layers. To represent the intermediate node/edge representations of layer k, we use, lower case h is used in the following and a super-script {.}^{(k)} is added to the notation to specify the layer. Specifically,

$${\{ {h}_{i}^{u} \}}^{( k )} , {\{ {h}_{j}^{υ} \}}^{( k )} , and {\{ {h}_{i , j}^{e} \}}^{( k )}$$

denote the k-th layer representation for node uᵢ, node vⱼ, and edge eᵢ, respectively.

The convolution operation of layer k takes the node representation of each node of layer k−1, i.e.

$${\{ {h}_{i}^{u} \}}^{( k - 1 )} and {\{ {h}_{j}^{υ} \}}^{\{ k - 1 \}}$$

as well as the edge representations of layer k−1, i.e.

$${\{ {h}_{i , j}^{e} \}}^{( k - 1 )}$$

and performs message passing and outputs new node and edge representations

$${\{ {h}_{i}^{u} \}}^{( k )} , {\{ {h}_{j}^{υ} \}}^{( k )} and {\{ {h}_{i , j}^{e} \}}^{( k )} .$$

Instead of training distinct representation for each node, a set of aggregator functions is trained that learns to aggregate feature information from a node's local neighbourhood.

To compute the new representations

$${\{ {h}_{i}^{u} \}}^{( k )} , {\{ {h}_{j}^{υ} \}}^{( k )}$$

for node or edge, the kth convolutional layer first collects the messages passed to the particular node/edge. The message to a node uᵢ or vᵢ come from the aggregator functions over the neighbouring node representations, the aggregator functions over the edge representations connected to uᵢ, and its own previous representations. The messages passed to an edge e_{i, j} come from the nodes connected to the edge, i.e., uᵢ and vⱼ, and the edges own previous representation.

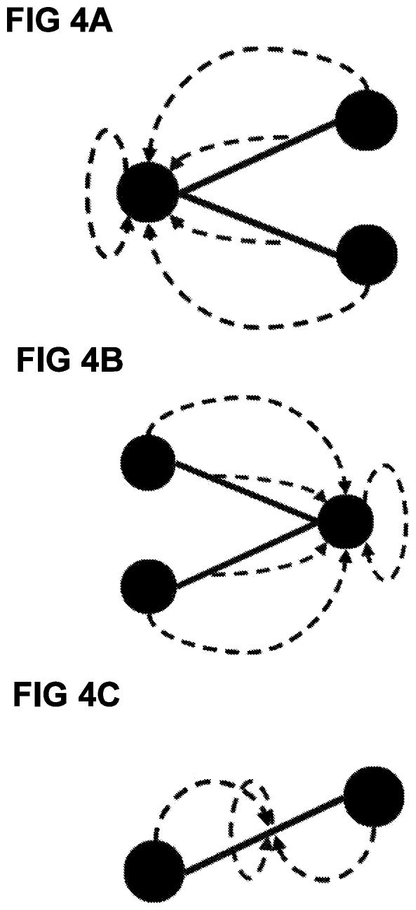

FIG. 4A illustrates the message passing flow for a customer node.

FIG. 4B illustrates the message passing flow for a service provider node.

FIG. 4C illustrates the message passing flow for an edge.

The following equations describe formally how the messages passed to uᵢ, vⱼ and e_{i, j} are computed:

$${Msg [ \to {u}_{i} ]}^{( k )} = \{ {\{ {h}_{i}^{u} \}}^{( k - 1 )} ⋃ Agg ( \{ {\{ {h}_{j}^{υ} \}}^{( k - 1 )} \vert ∀ {υ}_{j} ∈ 𝒩 ( {u}_{i} ) \} ) ⋃ Agg ( {\{ {h}_{i , j}^{e} \}}^{( k - 1 )} \vert ∀ {e}_{i , j} ∈ ℳ ( {u}_{i} ) \} ) \} \qquad ( 1 )$$

$${Msg [ \to {υ}_{j} ]}^{( k )} = \{ {\{ {h}_{j}^{υ} \}}^{( k - 1 )} ⋃ Agg ( \{ {\{ {h}_{j}^{u} \}}^{( k - 1 )} \vert ∀ {u}_{i} ∈ 𝒩 ( {υ}_{j} ) \} ) ⋃ Agg ( {\{ {h}_{i , j}^{e} \}}^{( k - 1 )} \vert ∀ {e}_{i , j} ∈ ℳ ( {υ}_{j} ) \} ) \} \qquad ( 2 )$$

$${Msg [ \to {e}_{i , j} ]}^{( k )} = \{ {\{ {h}_{i , j}^{e} \}}^{( k - 1 )} ⋃ {\{ {h}_{i}^{u} \}}^{( k - 1 )} ⋃ {\{ {h}_{j}^{υ} \}}^{( k - 1 )} \} . \qquad ( 3 )$$

Here, ∪ represents the concatenation operator, where messages that come from different sources are concatenated. The aggregation function Agg could be a simple aggregation function like Mean and Max, a combination of both, or more complex aggregation functions mentioned like LSTM (Long Short-Term Memory) and Pooling.

After collecting the messages for each node and edge, the convolutional layer computes the next representations (i.e. its output representations). For this, the messages processed by a linear operation parameterized by parameters W and b. The output of the linear operation is normalized passed to an activation function as follows:

$${\{ {h}_{i}^{u} \}}^{( k )} = ReLU ( BN ( {W}_{u}^{( k )} \cdot {Msg [ \to {u}_{i} ]}^{( k )} + {b}_{u}^{( k )} ) ) \qquad ( 4 )$$

$${\{ {h}_{j}^{υ} \}}^{( k )} = ReLU ( BN ( {W}_{υ}^{( k )} \cdot {Msg [ \to {υ}_{j} ]}^{( k )} + {b}_{υ}^{( k )} ) ) \qquad ( 5 )$$

$${\{ {h}_{i , j}^{e} \}}^{( k )} = ReLU ( BN ( {W}_{e}^{( k )} \cdot {Msg [ \to {e}_{i , j} ]}^{( k )} + {b}_{e}^{( k )} ) ) , \qquad ( 6 )$$

where BN represents a batch normalization layer. The weight and bias parameters in the linear operation for each node-set are shared across all nodes in the set. Similarly, the parameters for the edge set are shared across all edges. Hence, in one convolution layer, there are six parameter vectors: W^{u}, W, W^{e}, b^{u}, b^{v}, and b^{e}. These parameters are trained when training the neural network 300.

As mentioned above, the encoder 301 comprises K/2 graph convolution layers. The input to the first layer is the original feature for each node and edge of the input graph 305, i.e.

$$\begin{matrix}{\{ {h}_{i}^{u} \}}^{( 0 )} = {x}_{i}^{u} & {\{ {h}_{j}^{v} \}}^{( 0 )} = {x}_{j}^{v} & {\{ {h}_{i , j}^{e} \}}^{( 0 )} = {x}_{i , j}^{e} .\end{matrix} \qquad ( 7 )$$

The subsequent layers take the output of the previous layer as the input. Every layer outputs new node and edge representations,

$${\{ {h}_{i}^{u} \}}^{( k )} , {\{ {h}_{j}^{v} \}}^{( k )} and {\{ {h}_{i , j}^{e} \}}^{( k )} ,$$

except the last encoder layer (i.e. the K/2-th layer) which only outputs node representations

$${\{ {h}_{i}^{u} \}}^{( K / 2 )} and {\{ {h}_{j}^{v} \}}^{( K / 2 )} .$$

These node representations become the latent representation 306 (denoted as z) for each node in U and V, i.e.

$$\begin{matrix}{z}_{i}^{u} = {\{ {h}_{i}^{u} \}}^{( K / 2 )} & {z}_{j}^{v} =\end{matrix} {\{ {h}_{j}^{v} \}}^{( K / 2 )} . \qquad ( 8 )$$

This construction forces the latent representation of each node to also encode all neighbouring edge features in addition to the local graphical structure and neighbouring node features.

The feature decoder 302 also consists of K/2 convolution layers. The first layer takes the latent representations 306 of the nodes in [symbol] and [symbol] as the input without accepting edge representations. Therefore the message collection in the message passing scheme is simplified to:

$${Msg [ \to {u}_{i} ]}^{( K / 2 + 1 )} = \{ {z}_{i}^{u} ⋃ Agg ( \{ {z}_{j}^{v} \vert ∀ {v}_{j} ∈ 𝒩 ( {u}_{i} ) \} ) \} \qquad ( 9 )$$

$${Msg [ \to {v}_{j} ]}^{( K / 2 + 1 )} = \{ {z}_{j}^{v} ⋃ Agg ( \{ {z}_{i}^{u} \vert ∀ {u}_{i} ∈ 𝒩 ( {v}_{j} ) \} ) \} \qquad ( 10 )$$

$${Msg [ \to {e}_{i , j} ]}^{( K / 2 + 1 )} = \{ {z}_{i}^{u} ⋃ {z}_{j}^{v} \} . \qquad ( 11 )$$

The remaining convolution layers for the feature decoder 302 follow the scheme as described for the encoder 301. The output of the last layer of the decoder 302 becomes the reconstructed node and edge features, i.e.:

$$\begin{matrix}{\hat{x}}_{i}^{u} = {\{ {h}_{i}^{u} \}}^{( K )} & {\hat{x}}_{j}^{v} = {\{ {h}_{j}^{v} \}}^{( K )} & {\hat{x}}_{i , j}^{e} = {\{ {h}_{i , j}^{e} \}}^{( K )}\end{matrix} , \qquad ( 12 )$$

which are compared to the original input features for calculation of the loss 304 (in training) and the anomaly scores (in inference).

In the feature decoder 302, the graph structure is given to the model as the basis for passing the messages. Therefore, in order to strengthen the latent variable's encoding of the graph structure, the structure decoder 303 is included in the neural network 300. From the latent representations 306

$${z}_{i}^{u} and {z}_{j}^{v} ,$$

the structure decoder 303 tries to predict if a node uᵢ in [symbol] is connected to a node vⱼ in [symbol] . It works by passing

$${z}_{i}^{u}$$

to K/2 layers of a first multi layer perceptron 307 (MLPᵤ) and passing

$${z}_{j}^{v}$$

to a similar (second) MLP 308 (MLPᵥ). It then uses the dot product of the output of the MLPs, and passes it to a sigmoid function 309 to produce the probability of uᵢ being connected to vⱼ, i.e.:

$$Pr ( {A}_{i , j} = 1 ) = sigmoid ( M L {{P}_{u} ( {z}_{i}^{u} )}^{⊤} \cdot M L {P}_{v} ( {z}_{j}^{v} ) ) . \qquad ( 13 )$$

These probabilities are then compared to the adjacency matrix A for calculation of the loss 304 (in training) and the anomaly scores (in inference).

In the following, training of the neural network 300 is explained.

The edge prediction formula in the structure decoder (Eq. 13) defines the probability for every pair of nodes in [symbol] and [symbol] . In practice, the majority of node pairs are not connected. Therefore, to gain more efficiency, the probability is computed for a subset of the pairs without incurring any performance degradation. Let [symbol] ⁺ denote the set of pairs where uᵢ and vⱼ are connected in the graph, whereas [symbol] ⁻ denotes the set of pairs that are not connected, i.e.:

$$\begin{matrix}{ε}^{+} = \{ ( i , j ) \vert {A}_{i , j} = 1 \} , & {ε}^{-} = \{ ( i , j ) \vert {A}_{i , j} = 0 \}\end{matrix} . \qquad ( 14 )$$

The set [symbol] ^{±} is defined as the set of all indices [symbol] ^{±}= [symbol] ⁺∪ [symbol] ⁻. According to one embodiment, in the training procedure, not all items in [symbol] ⁻ are used. Rather, only a small portion of [symbol] ⁻ is sampled and combined with [symbol] ⁺ to get the set of pairs used in the training [symbol] ^{±}, i.e.

$${\tilde{ε}}^{\pm } = {ε}^{+} ⋃ Sample ( {ε}^{-} ) . \qquad ( 15 )$$

Standard uniform random sampling of the negative pairs [symbol] ⁻ with a pre-specified number of samples, e.g., a small multiple of the number of positive pairs ( [symbol] ⁺) may be used.

The loss function 304 is a type of reconstruction loss. Let \hat{X}^{u}, \hat{X}^{ν} and \hat{X}^{e} be the matrices that contain the network's output for all nodes in [symbol] , all nodes in [symbol] , and all edges respectively. The training objective function (i.e. loss function) 304 is the combination of the mean squared error (MSE) of node feature reconstruction of the nodes in [symbol] , the MSE of node feature reconstruction of the nodes in, the MSE of edge feature reconstruction and the binary cross entropy (BCE) of the structure decoder's edge prediction:

$$ℒ = M S E ( {X}^{u} , {\hat{X}}^{u} ) + M S E ( {X}^{v} , {\hat{X}}^{v} ) + M S E ( {X}^{e} , {\hat{X}}^{e} ) + ηB C E ( {\tilde{ε}}^{\pm } )$$

$$where : M S E ( X , \hat{X} ) = \frac{1}{nm} {\sum }_{i = 1}^{n} {\sum }_{l = 1}^{m} {( {X}_{i , l} - {X}_{i , l} )}^{2} , and$$

$$B C E ( {\tilde{ε}}^{\pm } ) = - \frac{1}{\vert {\tilde{ε}}^{\pm } \vert} {\sum }_{( i , j ) ∈ {\tilde{ε}}^{\pm }} \{ {A}_{i , j} log ( Pr ( {A}_{i , j} = 1 ) ) + ( 1 - {A}_{i , j} ) log ( 1 - Pr ( {A}_{i , j} = 1 ) ) \} , \qquad ( 16 )$$

where η denotes a constant for balancing the MSE losses from the feature decoder 302 and the BCE loss from the structure decoder 303.

In the training process, forward propagation is first performed by feeding the input data (i.e. the training data elements, i.e. training input graphs) to the encoder 301 to produce the latent representations 306 which are then passed to both feature decoder 302 and structure decoder 303 to produce the reconstructed data. The value of the loss function is then computed as objective of the neural network optimization.

The training data elements may be input graphs based on historical or simulated transactions, for example from double party interactions between customer and merchant of a food delivery service (e.g. GrabFood) and/or mart transactions (e.g. GrabMart). Depending on the use case, other double-party interactions relevant for the respective use case can also be used such as data on passenger-driver interactions (e.g. from GrabCar and/or GrabBike).

Algorithm 1 provides the detailed step-by-step process of performing forward propagation, covering all the network components as discussed above.

Algorithm 1

```
Data: graph [symbol]    = ( [symbol] , [symbol] , [symbol]   , X^{u} X^{v}, X^{e}); even number of
      $layer K : parameters : {W}_{u}^{( k )} , {W}_{v}^{( k )} , {W}_{e}^{( k )} , {b}_{u}^{( k )} , {b}_{v}^{( k )} ,$
      $and {b}_{e}^{( k )} ; structure decoder ’ s MLPs : {MLP}_{u} and {MLP}_{v}$
Result: loss/objective value
```

| | |
|---|---|
| /* initial representations | */ |

${\{ {h}_{i}^{u} \}}^{( 0 )} ← {x}_{i}^{u} , ∀ i ∈ \{ 1 , ⋯ , {n}_{u} \} ;$
${\{ {h}_{i}^{v} \}}^{( 0 )} ← {x}_{j}^{v} , ∀ j ∈ \{ 1 , ⋯ , {n}_{v} \} ;$
${\{ {h}_{i , j}^{e} \}}^{( 0 )} ← {x}_{i , j}^{e} , ∀ {e}_{i , j} ∈ ℰ ;$

| | |
|---|---|
| /* encoder | */ |

for k ← 1 to K/2 do
| compute messages: Msg[→ uᵢ]^{(k)} and Msg[→ vⱼ]^{(k)},
| for all nodes in [symbol] and [symbol] using Eq. (1) and Eq. (2);
| $compute all node representations : {\{ {h}_{i}^{u} \}}^{( k )} and {\{ {h}_{j}^{v} \}}^{( k )} ,$
| using Eq. (4) and Eq. (5);
| if k ≠ K/2 then
| | compute Msg[→ e_{i,j}]^{(k)}for all edges using Eq. (3);
| └ $compute edge repr . : {\{ {h}_{i , j}^{e} \}}^{( k )} using Eq . ( 6 ) ;$
└

| | |
|---|---|
| /* latent representations | */ |

${z}_{i}^{u} ← {\{ {h}_{i}^{u} \}}^{( K / 2 )} , ∀ i ∈ \{ 1 , … , {n}_{u} \} ;$
${z}_{j}^{v} ← {\{ {h}_{j}^{v} \}}^{( K / 2 )} , ∀ j ∈ \{ 1 , … , {n}_{v} \} ;$

| | |
|---|---|
| /* feature decoder | */ |

for k ← K/2 + 1 to K do
| if k = K/2 + 1 then
| | compute Msg[→ uᵢ]^{(k)}, Msg[→ vⱼ]^{(k)}, and
| | Msg[→ e_{i,j}]^{(k)} Eq. (9), Eq. (10), and Eq. (11);
| else
| | compute Msg[→ uᵢ]^{(k)}, Msg[→ vⱼ]^{(k)}, and
| └ Msg[→ e_{i,j}^{(k)} Eq. (1), Eq. (2), and Eq. (3);
| $compute all representations : {\{ {h}_{i}^{u} \}}^{( k )} , {\{ {h}_{j}^{v} \}}^{( k )} and$
└ ${\{ {h}_{i , j}^{e} \}}^{( k )} , using Eq . ( 4 ) , Eq . ( 5 ) , and Eq . ( 6 ) ;$

| | |
|---|---|
| /* reconstructed features | */ |

${\hat{x}}_{i}^{u} ← {\{ {h}_{i}^{u} \}}^{( K )} , ∀ i ∈ \{ 1 , … , {n}_{u} \} ;$
${\hat{x}}_{j}^{v} ← {\{ {h}_{j}^{v} \}}^{( K )} , ∀ j ∈ \{ 1 , … , {n}_{v} \} ;$
${\hat{x}}_{i , j}^{e} ← {\{ {h}_{i , j}^{e} \}}^{( K )} , ∀ {e}_{i , j} ∈ ℰ ;$

| | |
|---|---|
| /* structure decoder | */ |

perform negative sampling, combine it with [symbol] as [symbol] ^{±};
compute edge probability Pr(A_{i,j} = 1), ∀(i, j) ∈ [symbol] ^{±};
/* loss/objective value [symbol]
← compute loss using Eq. (16);
return

[symbol]

For computing backward propagation to compute the gradients and updating the neural network 300, a deep learning framework may be used.

After training the network, the anomaly scoring system 204 may use the neural network 300 to determine the anomaly scores as described above and explained in the following in more detail.

According to one embodiment, the anomaly scoring system 204 generates the values of three anomaly scoring functions for scoring the edges as well as the nodes in [symbol] and [symbol] . Given an input graph 305, the scoring functions are computed by first performing a forward propagation through the encoder 301 and the decoders 303, 304 and then computing individual node/edge reconstruction errors. The edge scoring function is defined as the weighted combination of the reconstruction error of the edge features and the BCE error of predicting if the edge should exist in the graph, i.e.:

$${score}_{e} ( {e}_{i , j} ) = M S E ( {x}_{i , j}^{e} , {\hat{x}}_{i , j}^{e} ) + η B C E ( {e}_{i , j} ) , \qquad ( 17 )$$

where the constant η is the same constant used in the training objective. After that, we define the scoring function for the nodes in [symbol] and [symbol] . The anomaly score of a node is the combination of the reconstruction error of its node feature and aggregation of the anomaly score of all edges connected to the node, i.e.:

$${score}_{u} ( {u}_{i} ) = M S E ( {x}_{i}^{u} , {\hat{x}}_{i}^{u} ) + {Agg}_{{e}_{i , j} ∈ ℳ ( {u}_{i} )} {score}_{e} ( {e}_{i , j} ) \qquad ( 18 )$$

$${score}_{v} ( {v}_{j} ) = M S E ( {x}_{j}^{v} , {\hat{x}}_{j}^{v} ) + {Agg}_{{e}_{i , j} ∈ ℳ ( {v}_{j} )} {score}_{e} ( {e}_{i , j} ) . \qquad ( 19 )$$

The aggregation function Agg could be Mean or Max depending on the need of the applications. The rationale of the aggregation is that since the entity (customer, service provider or also an item depending on the application) are the actors of the interactions in the edges, an anomaly in the interactions should affect the anomaly score of the entities involved. In addition, an entity is usually involved in many interactions. Some of those interactions may be anomalous, whereas other interactions may be normal. The Max aggregation is more sensitive to a single anomaly in the interaction, whereas the Mean aggregation provides a complete overview of all interactions that involve the entity.

The training procedure as described above requires access to the full graph structure as well as all node and edge features. This full graph training is, however, not scalable to large size graphs. To be able to scale the learning algorithm to large graph data, stochastic training via minibatching and neighbourhood sampling may be performed.

Minibatching splits the large graph into minibatches, each consisting of a small sub-graph. For each minibatch, we compute the final output representation for the nodes and edges in the sub-graph (target sub-graph). Computing the output of a particular node/edge in the target sub-graph using graph convolution requires knowing the neighbours of the node/edge. Thus, given we have K convolution layers, the sub-graph is repeatedly expanded K times by sampling neighbouring nodes connected to the current sub-graph.

In addition, the flow of the message in the convolution from one layer to the next layer is stored.

Let U, V, and E (distinct from [symbol] , [symbol] ,ε) denote the components of a sub-graph that belong to the node-set [symbol] , node-set [symbol] , and edge set E, respectively. In the following, Fₛ_{₁}_{→s}_{₂} denotes the message flow from node/edge set s₁ in one layer to node/edge set s₂ in the next layer, where s represents either, v, or e. A message flow Fₛ_{₁}_{→s}_{₂} contains a tuple of the source and target of the message, e.g., F_{u→ν}=({u₂, u₃, u₅},{ν₄,ν₆}). Further, F_{→s} denotes the a set of all message flows pointing to s.

To create mini-batches of sub-graph, the nodes in one node-set, e.g., [symbol] , are enumerated and group them into mini-batches of u nodes depending on the batch size. Let U be a set that contains a mini-batch of u nodes. The target sub-graph is generated by randomly sampling v nodes in [symbol] that are connected to any nodes in U. The resulting sample consists of a set of v nodes V and a set of edges E that connects V to U. The sets U, V and E form the target sub-graph for this particular mini-batch. This sub-graph is expanded K times by sampling the neighbourhood of U and V, while simultaneously creating the message flow sequence F from layer to layer. It should be noted that the layers are traversed in a backward manner, since the start is a target subgraph that defines the output of the network. Algorithm 2 provides the detailed step-by-step procedure for creating the message flow sequence.

Algorithm 2

Data: graph [symbol] = ( [symbol] , [symbol] , [symbol] , X^{u,} X^{v}, X^{e}); even number of
layer K; A batch of u nodes U
Result: message flow sequence F

| | |
|---|---|
| /* create initial sub-graph | */ |

V, E ← sample neighboring υ nodes from U;

| | |
|---|---|
| /* iterate every layer in reverse order | */ |

for k ← K to 1 do
| ${V}^{′} , {E}_{1}^{′} ← sample neighboring v nodes of U from 𝒢 ;$
| ${U}^{′} , {E}_{2}^{′} ← sample neighboring u nodes of V from 𝒢 ;$
| ${F}_{\to u}^{( k )} ← \{ {F}_{v \to u} : ( V ⋃ {V}^{′} , U ) , {F}_{e \to u} : ( E ⋃ {E}_{1}^{′} , U ) \} ;$
| ${F}_{\to v}^{( k )} ← \{ {F}_{u \to v} : ( U ⋃ {U}^{′} , V ) , {F}_{e \to v} : ( E ⋃ {E}_{2}^{′} , V ) \} ;$
| ${F}_{\to e}^{( k )} ← \{ {F}_{u \to e} : ( U ⋃ {U}^{′} , E ⋃ {E}_{2}^{′} ) , {F}_{v \to e} : ( V ⋃ {V}^{′} , E ⋃ {E}_{1}^{′} ) \} ;$
| U ← U ∪ U′; V ← V ∪ V′;
| $E ← E ⋃ {E}_{1}^{′} ⋃ {E}_{2}^{′} ;$
└ $E ← E ⋃ {E}_{1}^{′} ⋃ {E}_{2}^{′} ;$
$F ← \{ ( {F}_{\to u}^{( k )} , {F}_{\to v}^{( k )} , {F}_{\to e}^{( k )} ) \vert k ∈ \{ 1 , … , K \} \} ;$
return F

To perform stochastic training, the forward propagation procedure (Algorithm 1) is adjusted to follow the generated message flow sequence. The gradient of the loss function is then used to perform stochastic updates of the neural network 300.

So far, an anomaly detection problem in a transductive setting has been discussed, where the model provides reasoning only on the observed data. A more general setting is the inductive setting, where the neural network 300 is also required to come up with a general principle.

A model that is capable of performing inductive learning can be applied to newly observed nodes/edges/sub-graphs, while a transductive-only model cannot. The inductive anomaly detection task can be defined as follows: given a bipartite node-and-edge-attributed graph G=( [symbol] , [symbol] , [symbol] ) for training and a newly observed (sub)graph G′=( [symbol] ′, [symbol] ′, [symbol] ′, X′^{u}, X′^{v}, X′^{e}) for evaluation, the task is to produce scoring functions applicable to each edge e∈ [symbol] ′, as well as each node u∈ [symbol] ′ and ν∈ [symbol] ′, such that the edges/nodes that differ singularly from the majority in terms both the structure and attribute information should be given higher anomaly score.

In the embodiment described above in model, the inductive capability comes from the convolution operation, message passing and aggregation, as well as neighbourhood sampling. The forward propagation for the encoder 301, feature decoder 302 and structure decoder 303 can be directly applied to the newly observed sub(graph) G′. The anomaly scoring functions discussed are also still applicable to G′.

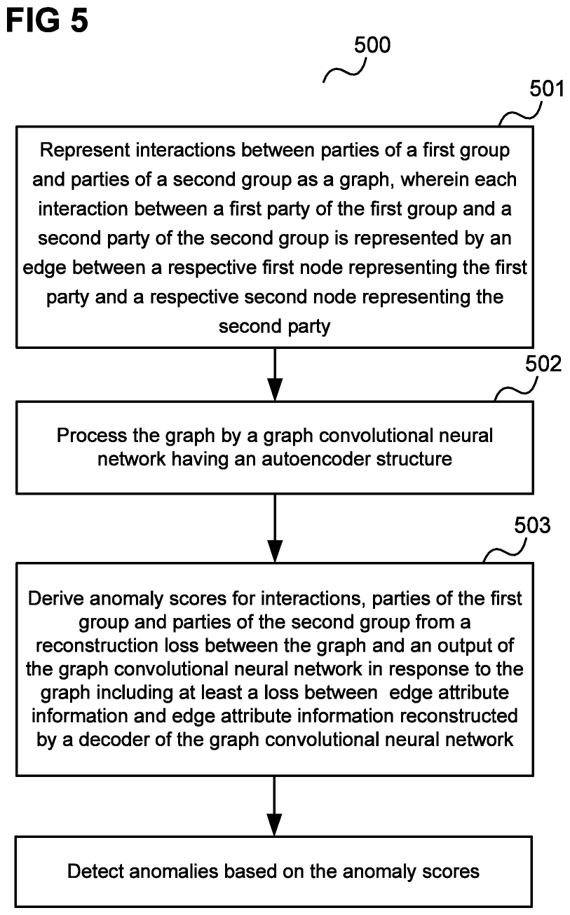

In summary, according to various embodiments, a method is provided as illustrated in FIG. 5.

FIG. 5 shows a flow diagram 500 illustrating a method for detecting anomalies in double-party interaction data.

In 501 interactions between parties of a first group and parties of a second group are represented as a graph, wherein each interaction between a first party of the first group and a second party of the second group is represented by an edge between a respective first node representing the first party and a respective second node representing the second party and wherein information about the first party is assigned to the first node as node attribute information, information about the second party is assigned to the second node as node attribute information and information about the interaction is assigned to the edge as edge attribute information.

In 502, the graph is processed by a graph convolutional neural network having an autoencoder structure.

In 503, anomaly scores for interactions, parties of the first group and parties of the second group are derived from a reconstruction loss between the graph and an output of the graph convolutional neural network in response to the graph including at least a loss between the edge attribute information and edge attribute information reconstructed by a decoder of the graph convolutional neural network.

In 504, anomalies are based on the anomaly scores.

According to various embodiments, in other words, anomalies are detected based (at least) on edges (i.e. double-party interactions, i.e. interactions between two parties) whose attribute can only be poorly reconstructed. If the decoder can only poorly reconstruct attribute information about an edge this can usually be an indication that the corresponding information is unusual, i.e. differs from interactions that the neural network has seen in its training and thus, that the interaction represents a behaviour which is not normal.

It should be noted that the double-party interaction data may in particular include sensor data and the parties may correspond to components of a technical system. In that case, the method may include performing a control action of the technical system in response to a detected anomaly which may hint to a failure in the interaction of components of the technical system like between robot devices in, for example, a manufacturing system comprising a plurality of robot devices or a vehicle in an autonomous driving scenario comprising a plurality of vehicles.

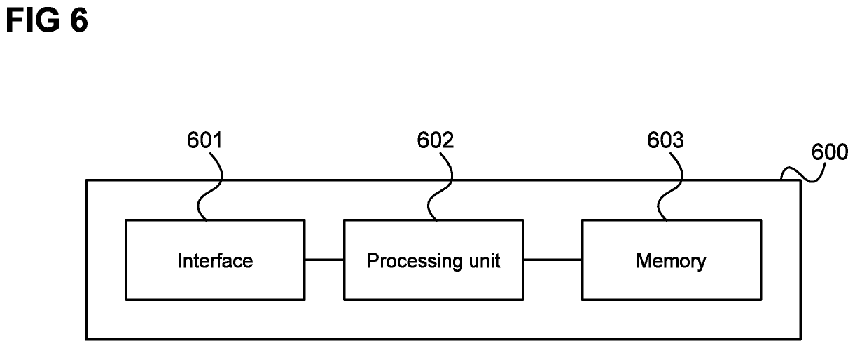

The method of FIG. 5 is for example carried out by a server computer as illustrated in FIG. 6.

FIG. 6 shows a server computer 600 according to an embodiment.

The server computer 600 includes a communication interface 601 (e.g. configured to receive interaction data, i.e. information about interactions). The server computer 600 further includes a processing unit 602 and a memory 603. The memory 603 may be used by the processing unit 602 to store, for example, data to be processed, such as information about interactions and nodes and its graph representation. The server computer is configured to perform the method of FIG. 5.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for detecting anomalies in double-party interaction data, comprising:
representing interactions between parties of a first group and parties of a second group as a graph, wherein each interaction between a first party of the first group and a second party of the second group is represented by an edge between a respective first node representing the first party and a respective second node representing the second party and wherein information about the first party is assigned to the first node as node attribute information, information about the second party is assigned to the second node as node attribute information and information about the interaction is assigned to the edge as edge attribute information;
processing the graph by a graph convolutional neural network having an autoencoder structure;
deriving anomaly scores for interactions, parties of the first group and parties of the second group from a reconstruction loss between the graph and an output of the graph convolutional neural network in response to the graph including at least a loss between the edge attribute information and edge attribute information reconstructed by a decoder of the graph convolutional neural network; and
detecting anomalies based on the anomaly scores.

2. The method of claim 1, wherein the reconstruction loss includes a loss between node attribute information and node attribute information reconstructed by the decoder.

3. The method of claim 1, wherein the reconstruction loss includes a loss between node adjacency information of the graph and node adjacency information reconstructed by the decoder.

4. The method of claim 1, comprising comparing the anomaly scores with one or more threshold values and detecting an anomaly of an interaction, party of the first group or party of the second group if its anomaly score is above a respective threshold value.

5. The method of claim 1, comprising training the graph convolutional neural network by, determining, for each training data element of a plurality of training data elements,
wherein each training data element comprises a training graph, a reconstruction loss between the training graph and an output of the graph convolutional neural network in response of the training graph and an output of the graph convolutional neural network in response to the graph including at least a loss between the edge attribute information and edge attribute information reconstructed by a decoder of the graph convolutional neural network, and
adapting the neural network to reduce an overall loss including the reconstruction losses determined for the training data elements.

6. The method of claim 5, comprising, for each training data element, sampling sub-graphs of the training graph, for each sampled sub-graph setting a reconstruction target to the sampled sub-graph and expanding the sub-graph by including nodes and edges connected to the sampled sub-graph and computing a reconstruction between the reconstruction target and an output of the graph convolutional neural network in response to the expanded sub-graph, wherein the overall loss includes the reconstruction losses determined for the sub-graphs.

7. The method of claim 1, wherein the first group of parties are customers and the second group of parties are service providers.

8. The method of claim 1, wherein the interactions are transactions between the first group of parties and the second group of parties.

9. The method of claim 1, comprising detecting fraud based on the detected anomalies.

10. The method of claim 9, comprising checking, for each detected anomaly, whether there has been fraud.

11. The method of claim 1, further comprising utilizing the anomaly score as the input to a human-in-the-loop actioning system and/or an automatic actioning system.

12. A server computer comprising a radio interface, a memory interface and a processing unit configured to perform a method for detecting anomalies in double-party interaction data comprising:
representing interactions between parties of a first group and parties of a second group as a graph, wherein each interaction between a first party of the first group and a second party of the second group is represented by an edge between a respective first node representing the first party and a respective second node representing the second party and wherein information about the first party is assigned to the first node as node attribute information, information about the second party is assigned to the second node as node attribute information and information about the interaction is assigned to the edge as edge attribute information;
processing the graph by a graph convolutional neural network having an autoencoder structure;
deriving anomaly scores for interactions, parties of the first group and parties of the second group from a reconstruction loss between the graph and an output of the graph convolutional neural network in response to the graph including at least a loss between the edge attribute information and edge attribute information reconstructed by a decoder of the graph convolutional neural network; and
detecting anomalies based on the anomaly scores.

13. (canceled)

14. A computer-readable medium comprising program instructions, which, when executed by one or more processors, cause the one or more processors to perform a method for detecting anomalies in double-party interaction data comprising:
representing interactions between parties of a first group and parties of a second group as a graph, wherein each interaction between a first party of the first group and a second party of the second group is represented by an edge between a respective first node representing the first party and a respective second node representing the second party and wherein information about the first party is assigned to the first node as node attribute information, information about the second party is assigned to the second node as node attribute information and information about the interaction is assigned to the edge as edge attribute information;
processing the graph by a graph convolutional neural network having an autoencoder structure;
deriving anomaly scores for interactions, parties of the first group and parties of the second group from a reconstruction loss between the graph and an output of the graph convolutional neural network in response to the graph including at least a loss between the edge attribute information and edge attribute information reconstructed by a decoder of the graph convolutional neural network; and
detecting anomalies based on the anomaly scores.
